(19) United States
(12) Patent Application Publication
(10) Pub. No.: US 2011/0220065 A1
(43) Pub. Date: Sep. 15, 2011

(54) Common Rail High Pressure Pump

(75) Inventor: Carsten Rudolph, Bendestorf (DE)

(73) Assignee: THIELERT AIRCRAFT ENGINES GMBH, Lichtenstein (DE)

(21) Appl. No.: 13/130,231

(22) PCT Filed: Nov. 17, 2009
(86) PCT No.: PCT/EP2009/065330

§ 371 Date: May 19, 2011

(30) Foreign Application Priority Data
Nov. 21, 2008 (DE) 10 2008 043 993.2

(51) Int. Cl. F02M 69/46

(52) U.S. Cl. 123/456

(57) ABSTRACT

A common rail high pressure pump for diesel engines operated using aircraft fuel, has an eccentric ring (2) that is disposed in a pump housing (13), shaped in the form of a polygon and driven by an eccentric shaft (1). The pump has pump pistons (8) that can move over the riding surfaces (4) of the eccentric ring and over the contact surface (5) of a tappet plate (3) in the pump cylinders (7) and that is in operative connection with a seating surface (10) of the tappet plate. A thin diamond-like carbon layer (12) is applied onto the previously ground contact surfaces (5) and riding surfaces (4), whereas the uncoated seating surface (10) is designed as a concave bulge. The eccentric ring (2) and the tappet plate (3) have a pre-determined high degree of hardness. Due to the synergistic effects caused by the material hardness and coating and the concave seating surface, the frictional forces are reduced by many times, and the life of the high pressure pump which operates on aircraft fuel is increased by many times.

### TECHNICAL FIELD

The invention relates to a common rail high-pressure pump for a diesel engine operated with aircraft fuel comprising an eccentric ring arranged in a housing shaped as polygon and driven by an eccentric shaft and pump pistons moveable via the riding surfaces of said eccentric ring and the contact surface of a tappet plate in pump cylinders which are in operative connection with a seating surface of the tappet plate.

### BACKGROUND

In diesel engines supplied with fuel according to the common rail principle, high-pressure pumps are employed in order to keep the fuel ready in a common distribution pipe (rail) at a pressure suitable for injection into the combustion chamber. A known common rail high-pressure pump for diesel engines operated with diesel fuel comprises an eccentric ring shaped as triangular polygon driven by the diesel engine via an eccentric shaft, whose riding surfaces in each case are in operative connection with a pump piston via a tappet acting as foot disc and which bring about the piston movement in a piston cylinder against the pressure of a helical compression spring. The eccentric shaft is located in a pump housing into which the fuel is introduced from a prefeed pump. During the downward movement of the respective piston brought about by the helical compression spring the fuel is sucked into the cylinder concerned and compressed during the upward movement and expelled into the distribution pipe. The lubrication of the eccentric shaft bearing, the friction surfaces between tappet and eccentric ring and between tappet and piston as well as the riding surfaces between the piston and cylinders is effected with the diesel fuel known to be used in diesel engines. The riding surfaces on the eccentric ring are subjected to a substantial load at the points at which the foot discs (tappet plates) of the pistons move back and forth. These riding surfaces are therefore designed with a wear protection layer. Using diesel engines as drive for aircraft has already been proposed. The use of diesel engines operated with the known high-pressure pumps according to the common rail principle using aircraft fuel based on kerosene in aircraft however is not possible because of the low lubricating effect of the aircraft fuel and the high wear of the friction partners of the high-pressure pump brought about as a result. When operating the diesel engine according to the common rail principle with aircraft fuel a total failure of the high-pressure pump must be expected even after a very short operating time.

A high-pressure pump described in DE 102 56 525 A1 for the fuel injection device of an internal combustion engine comprises an eccentric ring for moving the pump pistons via support elements, which slide on flats coated with amorphous carbon.

### SUMMARY OF THE INVENTION

The invention is therefore based on the object of stating a high-pressure pump for diesel engines operated according to the common rail principle which has a long lifespan even when using aircraft fuel.

According to the invention, the object is solved with a common rail high-pressure pump for a diesel engine operated with aircraft fuel having an eccentric ring arranged in a pump housing formed as a polygon and driven by an eccentric shaft and pump pistons moveable in pump cylinders via the riding surfaces of the eccentric ring and the contact surface of a tappet plate in operative connection with a seating surface of the tappet plate. The eccentric ring and the tappet plates each have a predetermined hardness and onto the previously ground contact surfaces and riding surfaces a thin carbon layer with a diamond-like effect is applied, while the uncoated seating surface is concavely curved. Practical configurations of the invention are discussed further below.

The essence of the invention consists in that with a common rail high-pressure pump for a diesel engine operated with aircraft fuel having an eccentric ring arranged in a pump housing, shaped as polygon and driven by an eccentric shaft and pump pistons moveable in pump cylinders via the riding surfaces of said eccentric ring and the contact surface of a tappet plate and in operative connection with a seating surface of the tappet plate, the eccentric ring and the tappet plates have a predetermined high hardness and onto the previously ground contact surfaces and riding surface a thin carbon layer acting in a diamond-like manner is applied, while the uncoated seating surface is concavely curved. Because of the synergistic effect between the hardness of the eccentric ring and the tappet plates as well as the thin carbon coating of the previously ground riding and contact surfaces and finally of the concavely curved design of the seating surfaces for the pump pistons the friction forces between the riding and contact surfaces despite the low lubricating power of the aircraft fuel used can surprisingly be so clearly reduced that the lifespan of the high-pressure pump is increased 500-fold. With the high-pressure pump designed according to the invention this means that employing diesel engines operated according to the common rail principle for aircraft making use of aircraft fuel is possible in the first place.

In an embodiment of the invention the eccentric ring consists of a highly tempered and hardened steel with a certain core hardness and an increased case hardness, wherein the case hardness of the eccentric ring is created through gas nitriting and is not less than 800 HV.

In a further configuration of the invention the tappet plates consist of a powder-metallurgical through-hardened high-speed steel with high toughness and fatigue strength, wherein the hardness of the tappet plate is not less than 800 HV10.

### BRIEF DESCRIPTION OF THE INVENTION

In a further configuration of the invention the concave curve of the seating surface is between 3 μm and 8 μm. An exemplary embodiment of the invention is explained in more detail by means of the drawing. It shows:

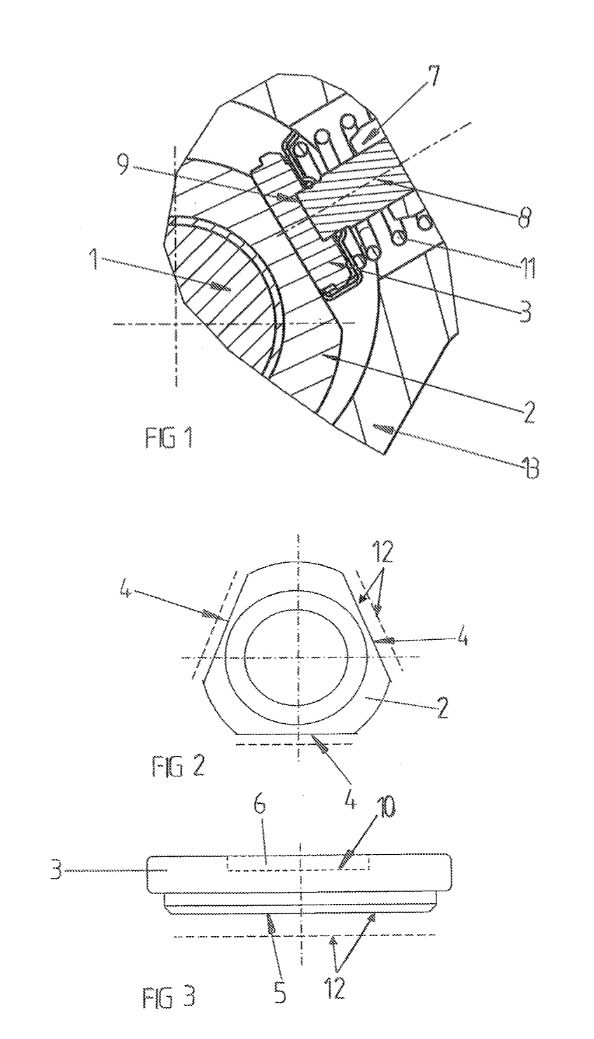

FIG. 1 a sectional view of a part of a high-pressure pump in the region of a substantial friction partner;

FIG. 2 a top view of the eccentric ring; and

FIG. 3 a lateral view of the tappet plate.

### DETAILED DESCRIPTION OF THE INVENTION

FIG. 1 shows a part view of a high-pressure pump in the region of the power transmission from an eccentric shaft 1 to a tappet plate 3 via an eccentric ring 2 designed as polygon. The tappet plate 3 is alternately moved radially to the outside and subsequently again to the inside corresponding to the eccentric rotary movement of the eccentric shaft 1. In the process, the riding surface 4 of the eccentric ring 2 (see FIG. 2) performs a backward and forward movement along the contact surface 5 of the tappet plate 3. In a receiving bore 6 of the tappet plate 3 (see FIG. 3) the one end of a pump piston 8 radially moveable backwards and forwards in a pump cylinder 7 is arranged. The end face 9 of the pump piston 8 contacts the seating surface 10 in the receiving bore 6, so that the pump piston 8 is radially moved to the outside against the force effect of a helical compression spring 11 and moved inwards again through the spring force.

As shown in FIG. 2 the eccentric ring 2 has three riding surfaces 4 arranged at an angle of 120° to one another, each of which is in operative connection with a pump piston 8 via a tappet plate 3. The pump housing of the high-pressure pump is designated with the reference number 13.

In order to minimize the extremely high friction forces between the contact surface 5 of the tappet plate 3 and of the riding surface 4 due in particular because of the use of aircraft fuel and its low lubricant effect, the riding surfaces 4 and the contact surfaces 5 are coated with a thin carbon coating 12 (DLC: Diamond Like Carbonite) having a diamond-like effect. The eccentric ring 2 consists of a highly tempered and hardened steel with a high basic strength and core hardness as well as a certain case hardness—preferentially achieved through gas nitriting. The tappet plates 3 are made from a powder-metallurgically produced and through-hardened high-speed steel. The base material of the eccentric ring 2 and of the tappet plates 3 is finished ground in the region of the riding surfaces 4 and of the contact surface 5 of the respective tappet plate 3. Through this design and surface finish of the base material, secure supporting and secure adhesion of the carbon layer 12 on the surface concerned (4, 5) is guaranteed. The seating surface 10 of the tappet plate 3 is not provided with the carbon layer (DLC layer) having a diamond-like effect. It is however designed concavely curved in the order of magnitude of approximately 3 to 8 μm in order to reduce the pressure of the pump piston 8 on the tappet plate 3 and thus the surface pressure between the riding surface 4 and the contact surface 5 and in addition to prevent punching through of the receiving bore 6 based on the force effect emanating from the end face 9 of the pump piston 8.

With such a design of the high-pressure pump for a diesel engine for aircraft supplied with fuel based on kerosene according to the common rail principle, seizure and cold-fusion between the eccentric ring 2 and the tappet plates 3 can be avoided despite the high surface pressure and the low lubricating power of the fuel and ultimately a lifespan of the high-pressure pump can be achieved that is approximately 500 times higher than the lifespan of the high-pressure pumps usually employed in automobile construction and which makes the application of common rail diesel engines in aircraft possible in the first place.

### LIST OF REFERENCE NUMBERS

1. Eccentric shaft
2. Eccentric ring
3. Tappet plates
4. Riding surface of 2
5. Contact surface of 3
6. Receiving bore of 3
7. Pump cylinder
8. Pump piston
9. End face of 8
10. Seating surface of 3
11. Helical compression spring
12. Carbon layer
13. Pump housing

1. A common rail high-pressure pump for a diesel engine operated with aircraft fuel comprising an eccentric ring (2) arranged in a pump housing (13) formed as polygon and driven by an eccentric shaft (1) and pump pistons (8) moveable in pump cylinders (7) via the riding surfaces (4) of said eccentric ring (2) and the contact surface (5) of a tappet plate (3) in operative connection with a seating surface (10) of the tappet plate (3), characterized in that the eccentric ring (2) and the tappet plates (3) each have a predetermined hardness and onto the previously ground contact surfaces (5) and riding surfaces (4) a thin carbon layer (12) with a diamond-like effect is applied, while the uncoated seating surface (10) is concavely curved.

2. The high-pressure pump according to claim 1, characterized in that the eccentric ring (2) consists of a highly tempered and hardened steel with a defined core hardness and an increased case hardness.

3. The high-pressure pump according to claim 2, characterized in that the case hardness of the eccentric ring (2) is created through gas nitriting and is not less than 800 HV.

4. The high-pressure pump according to claim 1, characterized in that the tappet plates (3) consist of a powder-metallurgical through-hardened high-speed steel with high toughness and fatigue strength.

5. The high-pressure pump according to claim 4, characterized in that the hardness of the tappet plate (3) is not less than 800 HV10.

6. The high-pressure pump according to claim 1, characterized in that the concave curvature of the seating surface (10) is between 3 μm and 8 μm.
